(19) United States
(12) Patent Application Publication
(10) Pub. No.: US 2021/0331373 A1
(43) Pub. Date: Oct. 28, 2021

(54) FABRIC STRUCTURE AND METHOD FOR MANUFACTURING THE SAME

(71) Applicant: SAN FANG CHEMICAL INDUSTRY CO., LTD., KAOHSIUNG CITY (TW)

(72) Inventors: KUO-KUANG CHENG, KAOHSIUNG CITY (TW); PAI-HSIANG WU, KAOHSIUNG CITY (TW); CHIEN-CHIA HUANG, KAOHSIUNG CITY (TW); TSUNG-YU TSAI, KAOHSIUNG CITY (TW); CHIEH LEE, KAOHSIUNG CITY (TW)

(21) Appl. No.: 17/239,394

(22) Filed: Apr. 23, 2021

(30) Foreign Application Priority Data
Apr. 24, 2020 (TW) 109113730

(51) Int. Cl. B29C 59/00; D06M 15/705

(52) U.S. Cl. CPC B29C 59/005; B29K 2105/0809; D06M 15/705

(57) ABSTRACT

The present disclosure provides a fabric structure including at least one fiber interlaced in a first pattern, and a surface layer having a second pattern not corresponding to the first pattern. The fiber includes a thermoplastic component and a functional component. The surface layer comprises a fused portion of the thermoplastic component and covers the functional component.

### BACKGROUND

### 1. Field of the Disclosure

The present disclosure relates to a fabric structure and a manufacturing method, and more particularly to a fabric structure having a treated surface, and a method for manufacturing the fabric structure.

### 2. Description of the Related Art

A conventional method for surface treatment of a fabric includes disposing a plastic film, which has a patterned surface, on a surface of the fabric, and then heating and pressing the plastic film onto the surface of the fabric, so as to bind the plastic film to the fabric. In this way, the fabric is provided with a special visual effect on its surface.

However, in the conventional method described above, the fabric and the plastic film must be produced separately, and a surface treating process must be conducted to pattern the surface of the plastic film. After the two separate processes for forming the fabric and the plastic film, still another process is needed to bind the plastic film to the fabric. The material preparation and production steps are complicated, resulting in high manufacturing costs. In addition, the plastic film may give the fabric a hard hand feel, greater thickness and weight, and diminished air permeability. Furthermore, since the fabric and the plastic film are formed separately and then bonded together, the binding strength may be poor, resulting in peeling of the plastic film.

### SUMMARY

To address at least some of the aforementioned issues, the present disclosure provides a fabric structure and a method for manufacturing the same, which method includes surface treatment of the fabric structure during a continuous process.

The present disclosure provides a fabric structure including at least one fiber interlaced in a first pattern, and a surface layer having a second pattern not corresponding to the first pattern. The fiber includes a thermoplastic component and a functional component. The surface layer comprises a fused portion of the thermoplastic component and covers the functional component.

The present disclosure further provides a method for manufacturing a fabric structure including: (a) providing at least one fiber comprising a thermoplastic component and a functional component; (b) interlacing the fiber in a first pattern to form a fabric; (c) covering the fabric with a release material, wherein the release material has an embossed pattern; and (d) heating and pressing the fabric onto the release material for fusing the thermoplastic component and forming a surface layer having a second pattern, wherein the second pattern is conformal to the embossed pattern of the release material.

### BRIEF DESCRIPTION OF THE DRAWINGS

FIG. 1 illustrates one or more stages of an example of a method for manufacturing a fabric structure according to some embodiments of the present disclosure.

FIG. 2 illustrates one or more stages of an example of a method for manufacturing a fabric structure according to some embodiments of the present disclosure.

FIG. 3 illustrates one or more stages of an example of a method for manufacturing a fabric structure according to some embodiments of the present disclosure.

FIG. 4 illustrates one or more stages of an example of a method for manufacturing a fabric structure according to some embodiments of the present disclosure.

FIG. 5 illustrates one or more stages of an example of a method for manufacturing a fabric structure according to some embodiments of the present disclosure.

FIG. 6 shows a photograph of a fabric structure according to an embodiment of the present disclosure.

FIG. 7 shows a photograph of a fabric structure according to an embodiment of the present disclosure.

### DETAILED DESCRIPTION

The present disclosure provides a fabric structure, comprising:
at least one fiber interlaced in a first pattern, wherein the fiber includes a thermoplastic component and a functional component; and
a surface layer having a second pattern not corresponding to the first pattern, wherein the surface layer comprises a fused portion of the thermoplastic component and covers the functional component.

Hereinafter in the present disclosure, the fiber has a length greater than a thousand times a width thereof. Preferably, the fiber is a filament fiber (or so-called filament), which is a fiber with a continuous length. For example, a length-to-width ratio of the filament fiber is greater than 10⁸.

In one embodiment of the present disclosure, the at least one fiber is a composite fiber including both the thermoplastic component and the functional component. The composite fiber includes, but is not limited to, a core-sheath fiber, a side-by-side fiber, or a segmented-pie fiber. Preferably, the thermoplastic component is exposed on the surface of the thermoplastic fiber, such that the thermoplastic component can be fused by heat (or by heat and pressure). For example, in one embodiment of the present disclosure, the fiber is a core-sheath fiber. A core of the fiber includes the functional component, and a sheath of the fiber includes the thermoplastic component and covers the core.

However, in another embodiment of the present disclosure, the at least one fiber includes a first fiber and a second fiber. The first fiber includes the thermoplastic component, and. the second fiber includes the functional component. The first fiber and the second fiber may jointly form the fabric structure of the present disclosure. For example, the first fiber and the second fiber may be used as warp and weft respectively for weaving. Alternatively, the first fiber and the second fiber may jointly form two-ply or multi-ply yarn, and then be interlaced together to form the fabric structure of the present disclosure.

The “thermoplastic component” refers to a component which is thermoplastic. Preferably, a material of the thermoplastic component is a thermoplastic elastomer, which includes, but is not limited to, thermoplastic polyurethane (TPU), thermoplastic polyester elastomer (TPEE) or thermoplastic polyolefin (TPO). The TPU, for example, includes polyester-based TPUs, which are mainly derived from adipic acid esters; and polyether-based TPUs, which are mainly based on tetrahydrofuran ethers. The TPEE, for example, includes polyethylene terephthalate (PET) and polybutylene terephthalate (PBT). The TPO, for example, includes polyethylene (PE) and polypropylene (PP).

Preferably, the thermoplastic component is translucent, such that the first pattern is also presented on the surface layer. That is, the first patter can be seen through the surface layer. The term “translucent” indicates that the thermoplastic component allows visible light to pass through, while the light path may or may not be affected by the thermoplastic component. For example, the thermoplastic component may be transparent or may scatter or reflect a portion of the visible light, which is not limited in the present disclosure.

The “functional component” refers to a fiber component which is generally not thermoplastic, but provides the fiber with other functions or properties. For example, the functional component may provide a fabric made therefrom with favorable elasticity and soft hand feel. Preferably, the functional fiber is not fused in the fabric structure of the present disclosure, so as to retain the first pattern. In one embodiment of the present disclosure, the functional component includes at least one material selected from the group consisting of polyene, polyamide, poly(p-phenylene terephthalamide), polyolefin, polymethyl methacrylate (PMMA), polyethylene terephthalate (PET), polytrimethylene terephthalate (PTT), polybutylene terephthalate (PBT), polyacrylonitrile (PAN), and a mixture thereof.

The term “pattern” refers to a visual effect caused by arrangement of color blocks, lines and shapes, or protrusions and recesses on a surface. For example, the first pattern may be an interlaced pattern corresponding to the interlacing method of the fiber, such as weaving, knitting, crocheting and braiding. In some embodiments, the at least one fiber may include a plurality of fibers with different colors, so as to allow more variety in the first pattern.

On the other hand, the second pattern may be an embossed pattern, which is mainly formed by arrangement of protrusions and recesses. For example, the second pattern may be formed by transfer-forming an embossed pattern of a release material onto the surface layer. In one embodiment of the present disclosure, when a dimension (e.g., height) of the second pattern is small, the second pattern may scatter or reflect light, thus providing a matte or rainbow reflective effect to the surface layer. Preferably, a height of the second pattern is less than a thickness of the fabric structure.

The surface layer includes a fused portion of the thermoplastic component and covers the functional component. The surface layer may be a thin layer, and is preferably exposed on a surface of the fabric structure, The “fused portion” is one or more portions of the thermoplastic component of the fiber, which were melted by heat and/or pressure, and were attached to each other or attached to the functional component, thus forming the surface layer after cooling. In other words, the thermoplastic component may include the fused portion which forms the surface layer, and may also include an unfused portion which retains the original shape of the fiber. Since the fused portion is connected with the unfused portion, the surface layer may not easily peel off from the fabric structure. In comparison with a conventional fabric structure having an additional plastic film as a surface treatment layer, since the surface layer in the fabric structure of the present disclosure is formed from a portion of the fiber, the weight and thickness of the fabric structure may not be increased by the surface layer. In addition, the fabric structure may not be hardened by the surface layer, and may retain a soft hand feel and may still be breathable.

In one embodiment of the present disclosure, the fabric structure includes a first region and a second region. The thermoplastic component is fused in the first region, and is not fused in the second region. That is, the first region of the fabric structure includes the surface layer, while the second region may not include, or may not be covered by, the surface layer. Accordingly, the first region and the second region may have different surface properties.

The present disclosure further provides a method for manufacturing a fabric structure, comprising:
(a) providing at least one fiber comprising a thermoplastic component and a functional component;
(b) interlacing the fiber in a first pattern to form a fabric;
(c) covering the fabric with a release material, wherein the release material has an embossed pattern; and
(d) heating and pressing the fabric to the release material for fusing the thermoplastic component and forming a surface layer having a second pattern, wherein the second pattern is conformal to the embossed pattern of the release material.

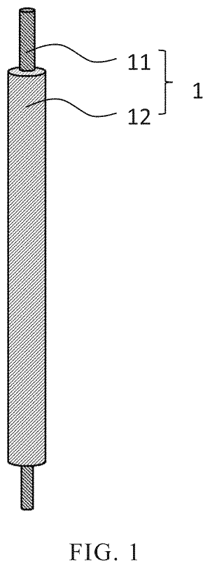

Referring to FIG. 1, in step (a), a fiber 1 is provided. In one embodiment of the present disclosure, the fiber 1 has a core-sheath structure. The core includes the functional component 11, and the sheath includes the thermoplastic component 12 covering the core.

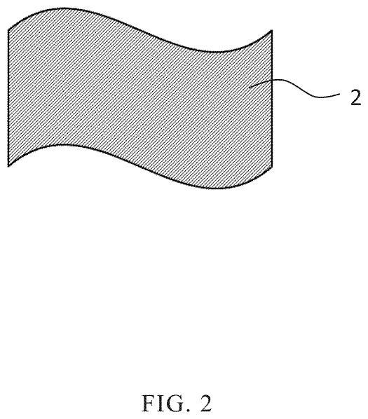

Referring to FIG. 2, in step (b), the fiber 1 is interlaced in a first pattern to form a fabric 2, As described above, the fiber 1 may be interlaced by weaving, knitting, crocheting or braiding to form the fabric 2, and the first pattern corresponds to the interlacing method.

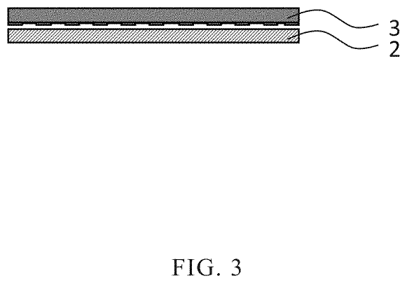

Referring to FIG. 3, in step (c), a release material 3 is applied on and covers the fabric 2. The release material 3 has an embossed pattern. The release material 3 may be a casting paper having protrusions and recesses on its surface to form the embossed pattern.

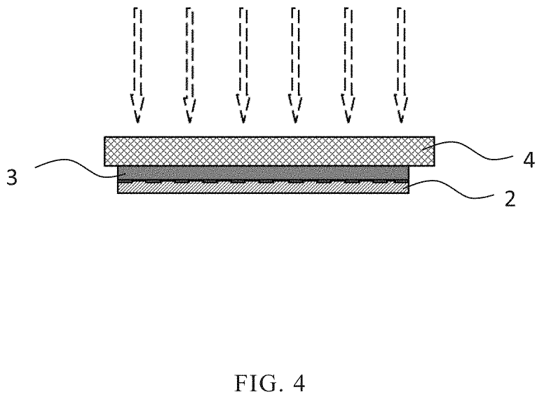

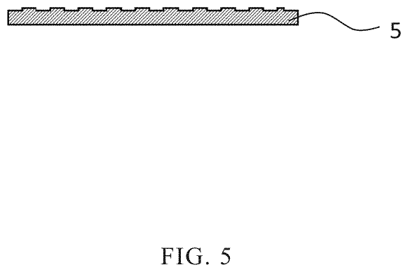

Referring to FIG. 4, in step (d), the fabric 2 is heated and pressed onto the release material 3 for fusing the thermoplastic component 12 and forming a surface layer having a second pattern. The second pattern is conformal to the embossed pattern of the release material 3. For example, a mold 4 (such as rollers or flat plates) may be used for the heating and pressing process, such that a force may be evenly applied to the entire surface or a predetermined region of the fabric 2. Preferably, in step (d), the functional component 11 is not fused in the fabric structure and the first pattern retains. Finally, as shown in FIG. 5, the release material 3 is removed to obtain the fabric structure 5 of the present disclosure.

The method of the present disclosure can perform surface processing (such as forming the surface layer) of the fabric 2 in a continuous process, thus forming the fabric structure 5. Hence, processes of preparing a plastic film separately and binding the plastic film to the fabric, as described in the conventional method above, can be omitted. The material preparation and production steps can be simplified to reduce manufacturing costs.

in one embodiment of the present disclosure, the fabric may include a first region and a second region. Accordingly, step (d) may include heating and pressing only the first region, such that the thermoplastic component is fused in the first region, and is not fused in the second region. That is, in the resultant fabric structure 5, merely the first region has the second pattern, The second region does not have the second pattern, but directly presents the first pattern.

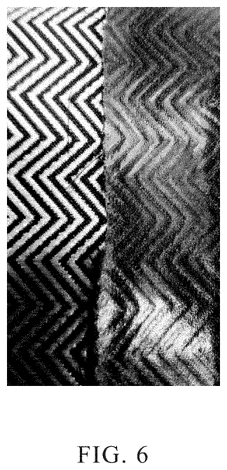

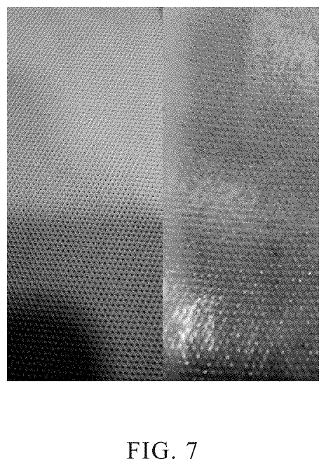

FIG. 6 shows a photograph of an example of a fabric structure according to an embodiment of the present disclosure. The left part shows the fabric formed in step (b), which presents a first pattern formed by an interlacing method. The right part shows the fabric structure after step (d), which includes a surface layer having a second pattern. The second pattern provides a visual effect, such as a matte or rainbow reflective effect, Similarly, FIG. 7 shows a photograph of an example of a fabric structure according to another embodiment of the present disclosure.

While the present disclosure has been described and illustrated with reference to specific embodiments thereof, these descriptions and illustrations are not limiting, It should be understood by those skilled in the art that various changes may be made and equivalents may be substituted without departing from the true spirit and scope of the present disclosure as defined by the appended claims. The illustrations may not necessarily be drawn to scale. There may be distinctions between the artistic renditions in the present disclosure and the actual apparatus due to manufacturing processes and tolerances. There may be other embodiments of the present disclosure which are not specifically illustrated. The specification and drawings are to be regarded as illustrative rather than restrictive. Modifications may be made to adapt to a particular situation, material, composition of matter, method, or process in accordance with the objective, spirit and scope of the present disclosure. All such modifications are intended to be within the scope of the claims appended hereto. While the methods disclosed herein have been described with reference to particular operations performed in a particular order, it will be understood that these operations may be combined, sub-divided, or re-ordered to form an equivalent method without departing from the teachings of the present disclosure. Accordingly, unless specifically indicated herein, the order and grouping of the operations are not limitations of the present disclosure.

What is claimed is:

1. A fabric structure, comprising:
at least one fiber interlaced in a first pattern, wherein the fiber includes a thermoplastic component and a functional component; and
a surface layer having a second pattern not corresponding to the first pattern, wherein the surface layer comprises a fused portion of the thermoplastic component and covers the functional component.

2. The fabric structure of claim 1, wherein the thermoplastic component is translucent, and the first pattern can be seen through the surface layer.

3. The fabric structure of claim 1, wherein a height of the second pattern is less than a thickness of the fabric structure.

4. The fabric structure of claim 1, wherein the functional component is not fused in the fabric structure to retain the first pattern thereby.

5. The fabric structure of claim 1, which includes a first region and a second region, wherein the thermoplastic component is fused in the first region, and is not fused in the second region.

6. The fabric structure of claim 1, wherein the fiber is a core-sheath fiber, a core of the fiber comprises the functional component, and a sheath of the fiber comprises the thermoplastic component and covers the core of the fiber.

7. The fabric structure of claim 1, wherein the at least one fiber comprises a first fiber and a second fiber, the first fiber comprises the thermoplastic component, and the second fiber comprises the functional component.

8. A method for manufacturing a fabric structure, comprising:
(a) providing at least one fiber comprising a thermoplastic component and a functional component;
(b) interlacing the fiber in a first pattern to form a fabric;
(c) covering the fabric with a release material, wherein the release material has an embossed pattern; and
(d) heating and pressing the fabric onto the release material for fusing the thermoplastic component and forming a surface layer having a second pattern, wherein the second pattern is conformal to the embossed pattern of the release material.

9. The method of claim 8, wherein in step (d), the functional component is not fused to retain the first pattern thereby.

10. The method of claim 8, wherein the fabric includes a first region and a second region, and step (d) includes heating and pressing only the first region of the fabric for fusing the thermoplastic component in the first region, and wherein the thermoplastic component is not fused in the second region.
